(19) United States
(12) Patent Application Publication
(10) Pub. No.: US 2008/0217116 A1
(43) Pub. Date: Sep. 11, 2008

(54) Parking Brake

(75) Inventors: Roberto Bonfanti, Bergamo (IT); Luca Gozzini, Brescia (IT); Dario Ravasio, Bergamo (IT)

Correspondence Address: SHOEMAKER AND MATTARE, LTD, 10 POST OFFICE ROAD - SUITE 110, SILVER SPRING, MD, 20910, US

(73) Assignee: BREMBO CERAMIC SYSTEMS S.P.A., Stezzano (Bergamo) (IT)

(21) Appl. No.: 12/091,499

(22) PCT Filed: Oct. 28, 2005
(86) PCT No.: PCT/IT2005/000632

§ 371 Date: May 15, 2008

(51) Int. Cl. F16D 55/225

(52) U.S. Cl. 188/71.6; 188/71.1; 188/73.1; 188/72.1

(57) ABSTRACT

The present invention relates to a brake for a vehicle, comprising a disc and a shoe device. The disc comprises a braking band of a first material and a support bell of a second material. The braking band e comprises a radially inner track and two opposing friction surfaces which are planar and suitable to interact with a brake caliper. The support bell is suitable to be structurally connected to the braking band. The shoe device is suitable to radially act on the inner track.

### FIELD OF THE INVENTION

The object of the present invention is a parking brake, particularly a drum parking brake integrated in a disc service brake.

### BACKGROUND OF THE INVENTION

In the automotive industry, and generally the vehicle industry, braking devices are known to be divided into service brakes and parking brakes.

Service brakes are intended to dissipate the kinetic energy of the vehicle such that the run can be slowed down until the vehicle is stopped, when required.

On the other hand, parking brakes are intended to ensure that the vehicle, after it has been stopped, will not move under the influence of forces independent from the driver's will, such as under the effect of the gravitational force when the vehicle is stationary on a slope.

In the automotive industry, service brakes of the so-called “disc” type are known, inter alia, in which on the occurrence a pair of braking pads is clamped by means of a suitable caliper to the side surfaces of a disc that is connected with a vehicle wheel.

Known brake discs comprise a braking band that is firmly mounted on a support bell which is, in turn, connected with a vehicle wheel.

Built-up brake discs are also known, in which the braking band and the support bell are made of different materials.

The material with which the braking band is made can be thus selected based on its hardness, such that the wear resistance of the braking band is optimized over its operating life.

Similarly, the material with which the bell is made can be selected to optimize the ratio of the mass and the mechanical characteristics.

In view of these considerations, the braking bands are known to be made of cast iron or ceramic matrix composite material and the support bells are known to be made of and aluminium alloy.

By manufacturing the bell and braking band in two distinct pieces and suitably connecting these pieces to each other, the braking band can freely dilate in the radial direction under the influence of temperature, without being affected by the presence of the bell. The braking band can thus maintain its planarity while dilating, which is a clear functional advantage for the brake.

In the automotive industry, the use of parking brakes of the “drum” type, inter alia, is also known, in which on the occurrence a pair of brake shoes is urged by a suitable actuator against the inner surface of a drum that is connected with a vehicle wheel.

The support bell of a disc service brake is also known to be used as the drum of the parking brake. This solution is known as Drum-In-Hat or DIH. Thereby, the overall dimensions of the braking members can be reduced by housing the shoes and the parking brake actuator within the support bell of the disc service brake.

These known solutions are not without drawbacks, though each of them is widely appreciated for its own characteristics.

For example, the two solutions described above, i.e. the built-up brake and DIH, are not perfectly compatible with each other.

For example, when a DIH is selected to be placed in a support bell made of aluminium alloy, the manufacturing of this bell will be much more complex than a conventional one.

To be suitable for a DIH, in fact, a bell must be manufactured with such an axial development that an inner surface is developed which is sufficiently large for braking.

This axial dimensioning of the bell leads to an increase in the size and accordingly the mass thereof to an extent that the advantages pursued by providing the built-up disc are reduced.

Furthermore, since the interior of the bell has to provide a perfectly cylindrical surface for the DIH to operate in an effective manner, such a bell certainly requires at least a further tooling. This tooling implies an increase in the manufacturing time and costs.

### SUMMARY AND OBJECTS OF THE INVENTION

The object of the present invention is to devise and provide a disc brake allowing to overcome the drawbacks stated above with reference to prior art.

Particularly, the task of the present invention is to provide a disc brake that benefits from the advantages of both the built-up disc and DIH at the same time.

This object and this task are achieved by means of a brake in accordance with claim 1.

### BRIEF DESCRIPTION OF THE DRAWINGS

Further characteristics and the advantages of the brake according to the invention will be understood from the description below of preferred embodiments thereof, which is merely illustrative and non-limiting, with reference to the annexed figures, in which:

FIG. 1 shows a perspective view of a brake according to the invention placed in its operating condition;

FIG. 2 shows an axial view of the brake from FIG. 1;

FIG. 3.a shows a partially sectional view of a brake according to the invention;

FIG. 3.b is a detailed view of a detail of the section from FIG. 3.a;

FIG. 4 shows an axial view of the brake disc of a brake according to the invention;

FIG. 5.a shows a sectional view taken along the axis V-V from FIG. 4;

FIG. 5.b is a detailed view of a detail of the section from FIG. 5.a;

FIG. 5.c is a detailed view of a detail of the section from FIG. 5.a;

FIG. 6 shows a perspective view of a brake disc of a brake according to the invention;

FIG. 7 shows another perspective view of the brake from FIG. 1;

FIG. 8 shows an exploded view of the brake disc from FIG. 6;

FIG. 9 shows another exploded view of the brake disc from FIG. 6;

FIG. 10 schematically shows a partially sectional sector of a brake disc according to the invention;

FIG. 11 schematically shows the section along the plane XI-XI from FIG. 10;

FIG. 12 schematically shows a partially sectional sector of a brake disc according to the invention;

FIG. 13 schematically shows the section along the plane XIII-XIII from FIG. 12.

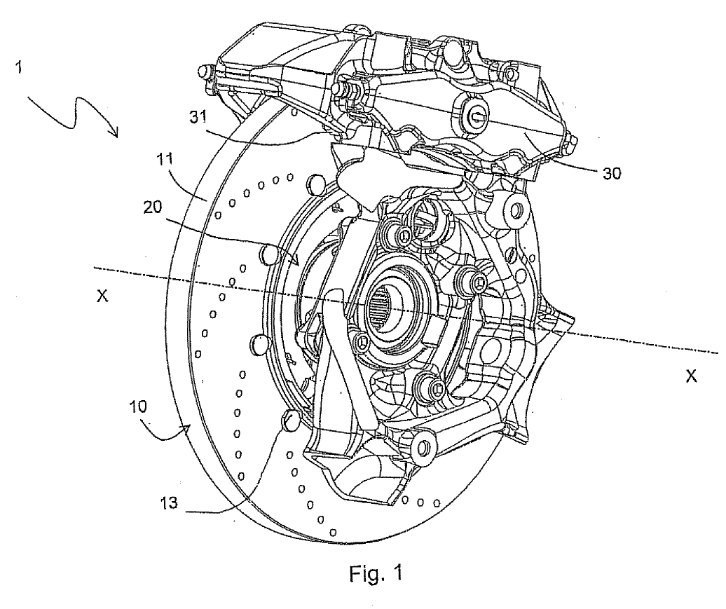

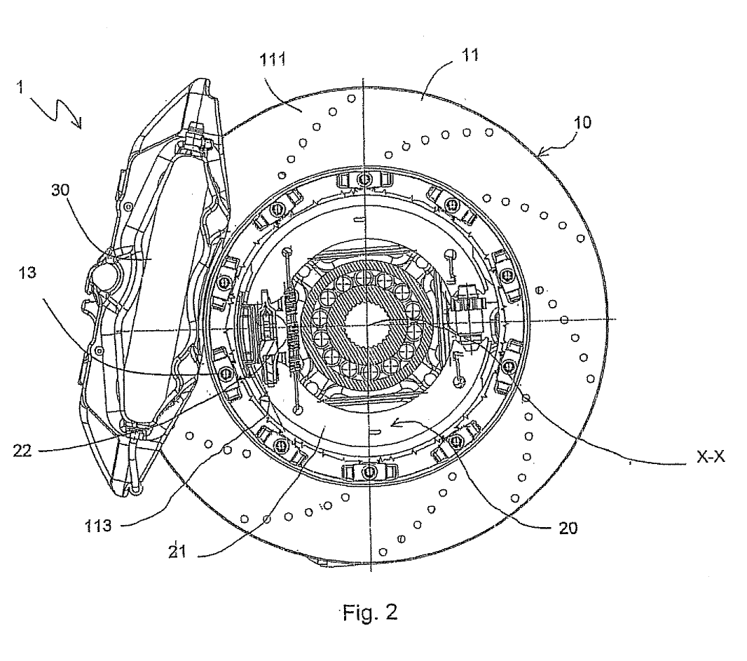

### DETAILED DESCRIPTION OF THE INVENTION

With reference to said drawings, the brake according to the invention is generally designated with 1 and comprises a brake disc 10 and a shoe device 20.

The brake disc 10 comprises, in turn, a braking band 11 and a support bell 12.

A number of term definitions is given herein below, which are used to describe the invention more clearly and without ambiguities. The braking band 11 has a development which is mainly parallel to a plane, such as the mid-plane π thereof.

The braking band 11 is intended to rotate about an axis, which is called X-X herein below and is perpendicular to the plane it.

The direction of a straight line parallel to the axis X-X is thus called the axial direction. The direction of a half-line originating on the axis X-X and perpendicular thereto is called the radial direction.

By “radially inner” is meant what is relatively near the axis X-X, whereas by “radially outer” is meant what is relatively far from the axis X-X.

The braking band 11 preferably has a central symmetry, which is centered on the axis X-X. The embodiment of the braking band 11 as illustrated in the accompanying drawings is substantially in the shape of an annular ring. In accordance with other embodiments, it may also have different shapes, for example multilobed shapes.

The braking band 11 is suitable to interact with conventional brake pads 31 which are clamped thereon by means of a common caliper 30 of a vehicle service brake. Particularly, in accordance with an embodiment, the braking band 11 comprises two friction surfaces 110 and 111 which are opposite to each other, plane and parallel to the plane T.

In a manner known per se, the service braking action is generated by the dragging contact occurring between the brake pads 31 and the friction surfaces 110 and 111.

In accordance with an embodiment, the braking band 11 also comprises ventilation ducts 112 which are formed in the thickness of the braking band 11 for cooling the brake disc. In fact, the kinetic energy of the vehicle, while braking with the service brake, is known to be turned into heat by the brakes, and this heat has to be accordingly released, possibly in an effective manner.

In accordance with an embodiment, the braking band 11 is made of a material allowing the same to withstand those constraints, both mechanical and thermal, to which it is subjected while braking.

At the same time, the material with which the braking band 11 is made allows optimizing the resistance to the wear to which it is subjected over its operating life.

In view of what has been stated above, the material with which the braking band 11 is made is preferably selected from cast iron and ceramic matrix composite materials.

The braking band 11 according to the invention further comprises an inner track 113.

In accordance with the embodiment as illustrated in the annexed figures, the inner track 113 is formed on the cylindrical surface that internally defines the annular ring forming the braking band.

In accordance with the embodiment as illustrated in the annexed figures, the inner track 113 has an annular profile, and is thus cylindrical and continuous without interruptions or discontinuities.

On the other hand, in accordance with other embodiments, the inner track 113 may have different profiles as will be described below.

The support bell 12 is suitable to be structurally connected to the braking band 11 on the one side and to the vehicle wheel on the other side. The main function of the support bell 12 is to transmit the braking torque generated by the interaction between the band 11 and the caliper 30 to the vehicle wheel.

Accordingly, the support bell 12 is usually made of a material providing those mechanical characteristics required for the transmission of the braking torque.

At the same time, the material of which the support bell 12 is made must limit the mass of the bell as much as possible, such that the unsuspended masses of the vehicle are reduced in order to improve the dynamics of the same.

In view of what has been stated above, the material with which the support bell 12 is made is usually selected from light aluminium alloys.

In accordance with the embodiment as illustrated in the drawings, the support bell 12 and the braking band 11 are connected by means of a plurality of connecting devices 13.

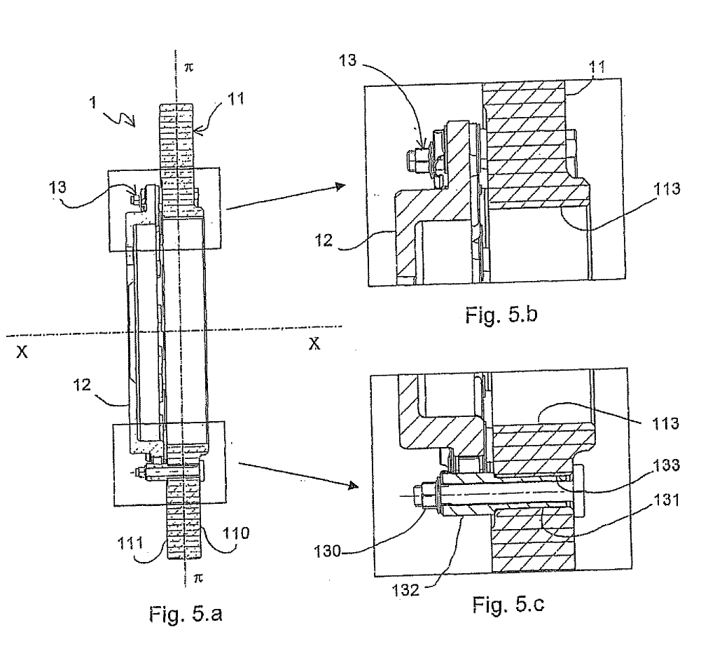

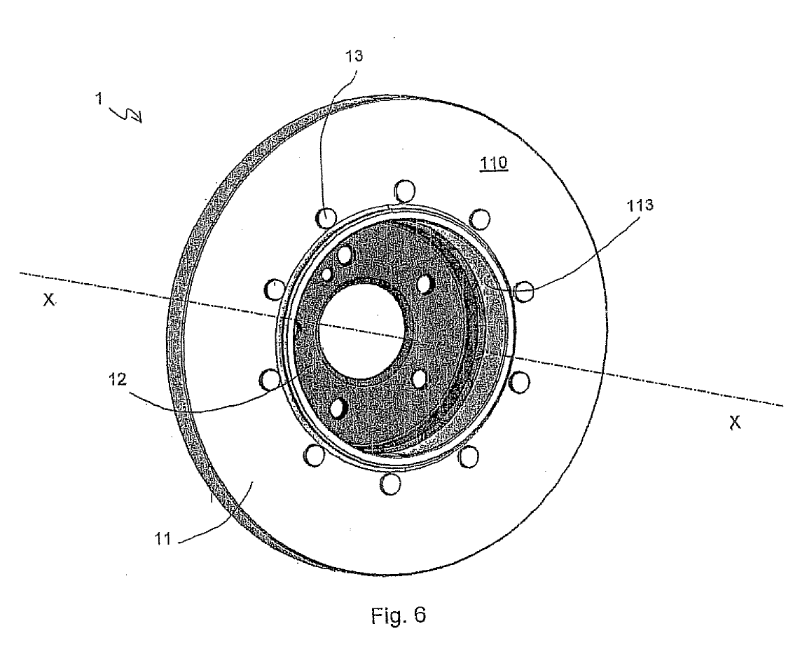

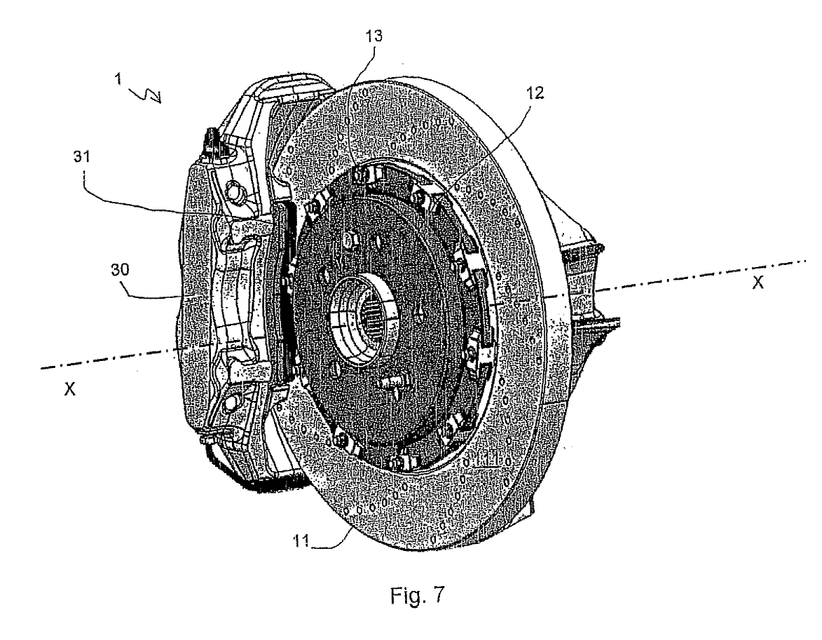

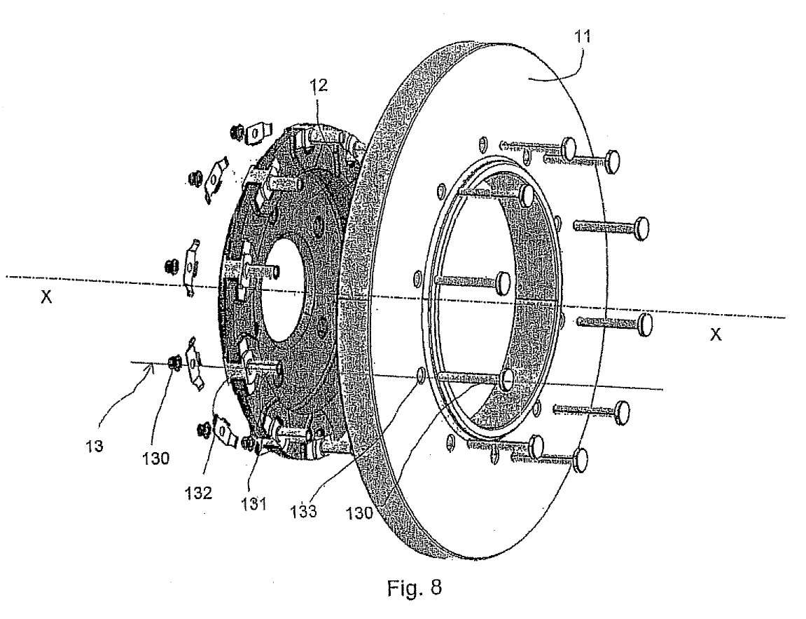

As may be particularly seen in FIG. 8, these connecting devices 13 have a substantially axial development. As may be also particularly seen in FIG. 5.a, 5.b and 5.c, the overall dimensions of the connecting devices 13 are limited to the radially innermost annular ring of the friction surfaces 111 and 110. Thereby, the overall dimensions of the connecting devices 13 do not affect the inner track 113, which can be reached radially from the inside also after the braking band 11 has been connected to the support bell 12.

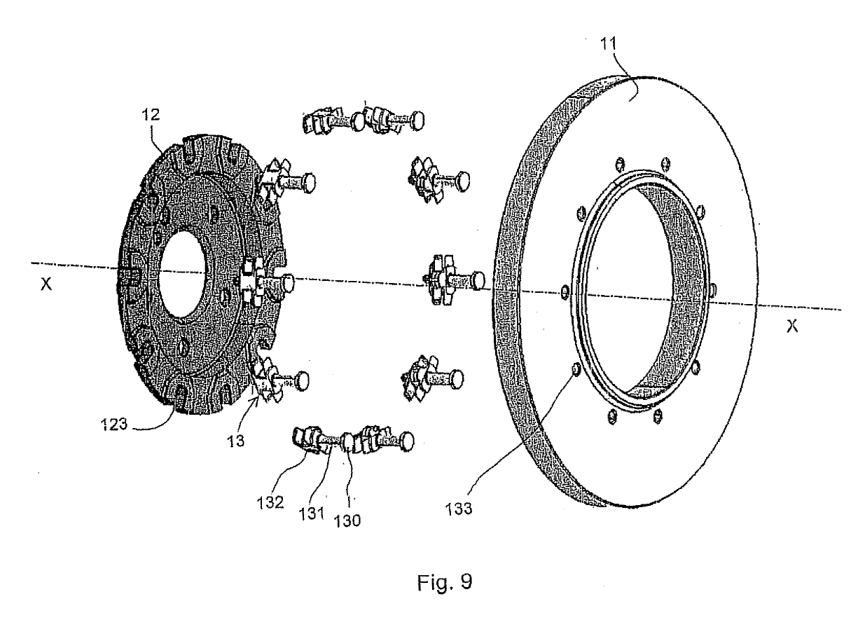

In accordance with the embodiment as illustrated in the FIG. 8 and 9, the connecting devices 13 comprise removable fastening means 130 (such as of the screw and nut type), shaped blocks 132 and pins 131. The support bell 12 comprises, in turn, radial slots 123 of a shape matching the shape of the shaped blocks 132. As may be clearly seen in FIG. 8, the shaped blocks are intended to be housed in the radial slots 123; the pins 131 are instead adapted to be housed in suitable axial seats 133 that are formed on the braking band 11. The removable fastening means 130 are finally suitable to axially fasten the assembly of connecting devices 13.

The shaped blocks 132 are suitable to slide in the radial direction along the radial slots 123 of the support bell 12. This characteristic of the fastening between the support bell 12 and the braking band 11 allows the braking band 11 to radially dilate under the temperature effect without being affected by the effects of the support bell 12.

As stated above, the brake 1 also comprises a shoe device 20, which is mounted within the brake disc 10. The shoe device 20 is thus of the DIH type, which is particularly appreciated because it provides an overall compactness to the vehicle braking members.

The shoe device 20 comprises at least one brake shoe 21 and an actuator 22. The actuator 22 is suitable, upon a suitable command of the vehicle driver, to thrust the brake shoe 21 radially outwardly from the inside. The actuator 22 is also suitable to hold the brake shoe 21 in the radially outmost position, until the driver of the vehicle gives a contrary command.

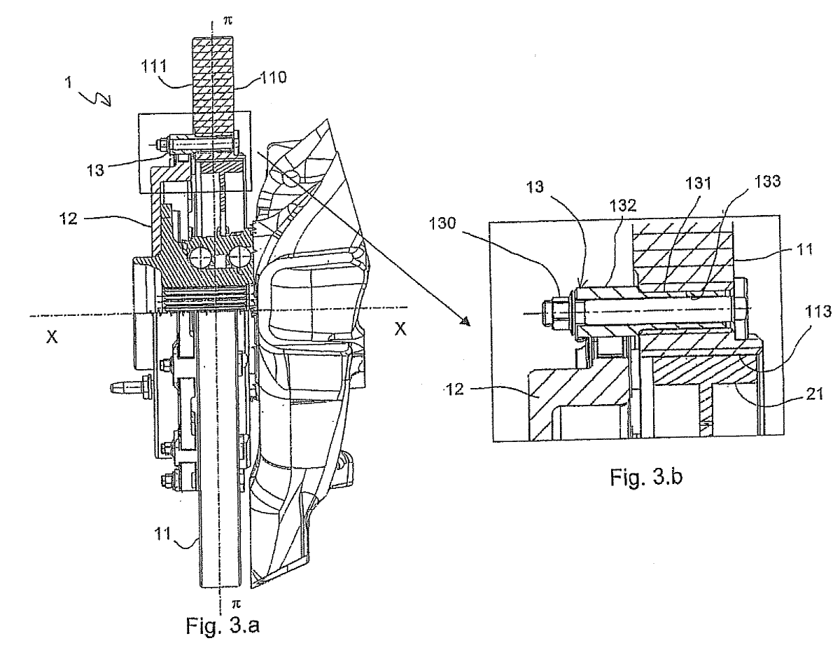

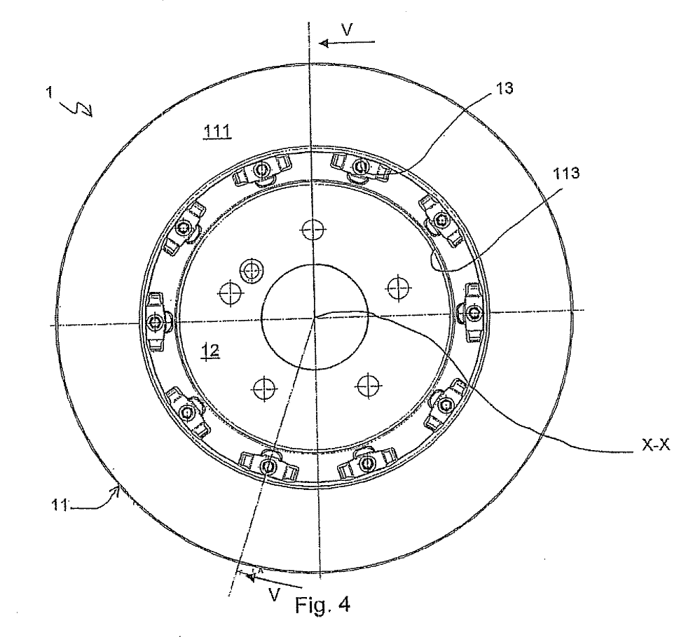

As may be clearly seen in FIG. 3.a and 3.b, the shoe device 20 of the brake 1 according to the invention is mounted in a position axially aligned with the braking band 11. In other words, when the actuator 22 thrusts the brake shoe 21 radially outwardly from the inside, the brake shoe 21 is pressed against the inner track 113 of the braking band 11 and thus carries out the parking braking of the vehicle.

In accordance with the embodiment such as illustrated, two brake shoes 21 are conventionally provided on the shoe device 20 for each brake. In accordance with other embodiments, the brake shoes 21 may also be provided in a greater number, according to the particular requirements.

As stated above, the inner track 113 of the band 11 can have profiles and developments other than the annular and continuous one illustrated in the figures.

Particularly, it may have non annular profiles and may be discontinuous or interrupted along the development thereof. Whatever the shape of the inner track 113, to the purposes of the present invention, it is necessary and sufficient that a cylindrical surface can be defined which is inscribed within the profile of the track, and tangential to the development thereof at a plurality of points or tracts.

In other words, the inner track 113 must be tangential, at least by tracts, to a cylindrical surface having axis X-X.

This cylindrical surface, which can be reached radially from the inside, is the abutment surface for the brake shoes 21 during the parking braking step.

By being annular and continuous, the inner track 113 ensures, the size being the same, a greater braking surface. That is, it ensures the broadest surface on which the contact between the inner track 113 and the brake shoes 21 is obtained.

Providing interruptions along the inner track 113, against a decrease in the braking surface, may be useful in view of particular design requirements.

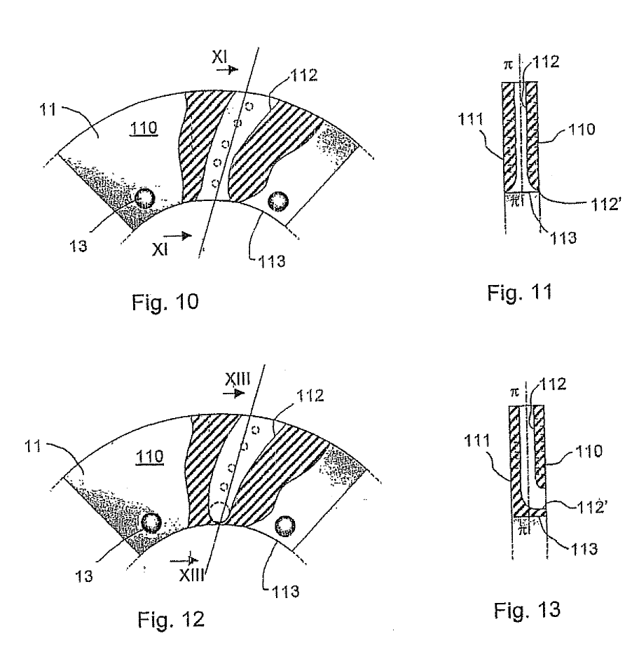

For example, with reference to the embodiment illustrated in FIGS. 10 and 11, it may be useful if a number of interruptions is created along the development of the inner track 113 for positioning at least several inlets 112′ for the ventilation ducts 112 being formed in the thickness of the braking band 11 for cooling the brake disc.

Another possible solution, as an alternative to that described above and illustrated in FIGS. 12 and 13, provides that the ventilation ducts 112 of the braking band 11 have a radially inner tract with axial development which joins to a radially outer tract with radial development. In this instance, the inlets 112′ of the ventilation ducts 112 are interposed between the connecting devices 13, in the innermost annulus of the braking band 11.

In view of the above description, it will be understood by those skilled in the art that the brake 1 according to the invention overcomes the drawbacks stated with respect to prior art.

In fact, the present invention provides a brake 1 having the characteristics, which are already widely appreciated, both of the built-up brakes and the Drum-In-Hat solution.

Particularly, the brake 1 according to the invention allows differentiating the selection of materials with which the braking band 11 and the support bell 12 are made, and at the same time, allows one to house the shoe device 20 of the parking brake.

In accordance with what has been stated above, the brake 1 according to the invention allows obtaining the parking braking on a track made of a material that is sufficiently hard to optimize the wear over the operating life of the brake. At the same time, the brake 1 according to the invention allows obtaining a lighter brake, due to the support bell being made of a light alloy and having a reduced axial size.

Finally, the brake 1 according to the invention allows the braking band to freely dilate under the effect of the operating temperature, while maintaining its planarity.

To the preferred embodiments of the brake described above, those skilled in the art, aiming at satisfying contingent requirements, may carry out a number of modifications, adjustments and replacements of elements with others functionally equivalent, without departing from the scope of the claims below. Each of the characteristics described as belonging to a feasible embodiment can be provided independently from the other embodiments described.

1. A brake for a vehicle, comprising:
a disc comprising:
a braking band of a first material, comprising two opposing friction surfaces which are planar and suitable to interact with a brake caliper, and a radially inner track, and
a support bell of a second material, which is suitable to be structurally connected to said braking band; and
a shoe device 2 which is suitable to radially act on said inner track.

2. The brake in accordance with claim 1, wherein said braking band has a central symmetry.

3. The brake in accordance with claim 1 wherein said braking band is substantially shaped as an annulus.

4. The brake in accordance with claim 1 wherein said braking band has a multilobal shape.

5. The brake in accordance with claim 1, wherein said braking band comprises ventilation ducts that are obtained in the thickness of said braking band.

6. The brake in accordance with claim 5, wherein said ventilation ducts comprise inlets that are placed along said radially inner track.

7. The brake in accordance with claim 5, wherein said ventilation ducts comprise inlets having an axial development and being placed along an inner annulus of said braking band.

8. The brake in accordance with claim 1, wherein said first material is cast iron.

9. The brake in accordance with claim 1, wherein said first material is a ceramic matrix composite material.

10. The brake in accordance with claim 1, wherein said radially inner track is formed on a surface that innerly defines said braking band and on which profile a cylindrical surface can be inscribed that is tangential in a plurality of points or tracts along the development of said profile.

11. The brake in accordance with claim 1, wherein said radially inner track is continuous and does not have interruptions or discontinuity.

12. The brake in accordance with claim 1 wherein said radially inner track is cylindrical.

13. The brake in accordance with claim 1, wherein said radially inner track is discontinuous and comprises interruptions along the development thereof.

14. The brake in accordance with claim 1, wherein said second material is selected from light aluminium alloys.

15. The brake in accordance with claim 1, wherein said support bell and said braking band are connected by means of a plurality of connecting devices.

16. The brake in accordance with claim 15, wherein said connecting devices have a substantially axial development.

17. The brake in accordance with claim 15, wherein said connecting devices are arranged on a radially inner annulus of said braking band.

18. The brake in accordance with claim 17, wherein said connecting devices are alternately arranged between said inlets of said ventilation ducts.

19. The brake in accordance with claim 15, wherein said connecting devices comprise:
shaped blocks which are suitable to be housed in radial slots that are obtained on said support bell;
pins suitable to be housed within axial seats that are formed on said braking band; and
removable fastening means suitable to axially fasten said connecting devices.

20. The brake in accordance with claim 19, wherein said shaped blocks are suitable to slide in the radial direction along said radial slots of said support belly.

21. The brake in accordance with claim 1, wherein said shoe device is of the Drum-In-Hat type.

22. The brake in accordance with claim 1, wherein said shoe device is mounted in an axially aligned position relative to said braking band.

23. The brake in accordance with claim 1, wherein said shoe device comprises at least one brake shoe and an actuator.

24. The brake in accordance with claim 23, wherein said actuator is suitable to radially thrust said at least one brake shoe outwardly from the inside.

25. The brake in accordance with claim 23, wherein said actuator is suitable to hold this brake shoe in the radially outer position, until a contrary command is given.
